(19) United States
(12) Patent Application Publication
(10) Pub. No.: US 2001/0033483 A1
(43) Pub. Date: Oct. 25, 2001

(54) Fluorescent lamp composed of arrayed glass structures

(76) Inventor: Chad Byron Moore, Corning, NY (US)

Correspondence Address: BROWN PINNISI & MICHAELS, 400 M & T BANK BUILDING, 118 NORTH TIOGA ST, ITHACA, NY, 14850

(21) Appl. No.: 09/796,985

(22) Filed: Mar. 1, 2001

Related U.S. Application Data
(60) Provisional application No. 60/186,026, filed on Mar. 1, 2000.

(51) Int. Cl. F21S 4/00

(52) U.S. Cl. 362/84; 362/260; 362/267; 362/351

(57) ABSTRACT

The present disclosure teaches using at least one array of linear glass structures that contain at least one wire electrode running the length of the glass structure to fabricate a fluorescent lamp. At least one of the linear glass structures has a cross-section that forms a channel which supports a plasma gas. The array of glass structures can be composed flat to form a fluorescent lamp or in a cylindrical or conical shaped fluorescent lamp.

### REFERENCE TO RELATED APPLICATIONS

This application claims an invention which was disclosed in Provisional Application No. 60/186,026, filed Mar. 1, 2000, entitled “FLUORESCENT LAMP COMPOSED OF ARRAYED GLASS STRUCTURES”. The benefit under 35 USC § 119(e) of the United States provisional application is hereby claimed, and the aforementioned application is hereby incorporated herein by reference.

### BACKGROUND OF THE INVENTION

1. Field of the Invention

The invention pertains to the field of fluorescent lighting. More particularly, the invention pertains to using glass structures, such as fiber, to construct a fluorescent lamp.

2. Description of Related Art

Previous work exists in creating plasma display using wire electrode(s) into glass fibers to produce the structure in a display. This work was initially published by C. Moore and R. Schaeffler, “Fiber Plasma Display”, SID '97 Digest, pp. 1055-1058. A U.S. Pat. No. 5,984,747 GLASS STRUCTURES FOR INFORMATION DISPLAYS was granted on Nov. 16, 1999 pertaining to fiber-based displays.

A fiber-based plasma display patent application Ser. No. 09/299,370 FIBER-BASED PLAMSA DISPLAYS was submitted covering many different aspects of the fiber-based plasma display technology and is incorporated herein by reference. Manufacturing of fiber-based plasma displays were covered under patent application Ser. Nos. 09/299,350 and 09/299,371 entitled PROCESS FOR MAKING ARRAY OF FIBERS USED IN FIBER-BASED DISPLAYS and FRIT-SEALING PROCESS USED IN MAKING DISPLAYS. These two patent applications cover producing any multiple-strand arrayed display and could easily cover making multiple stand fiber-based fluorescent tubs and are incorporated herein by reference. In addition a patent application Ser. No. 09/299,394 LOST GLASS PROCESS USED IN MAKING FIBER-BASED DISPLAYS was submitted to cover exposing an electrode or holding the exact fiber shape in a fiber-based plasma display and is incorporated herein by reference.

### SUMMARY OF THE INVENTION

The present invention teaches using at least one array of linear glass structures that contain at least one wire electrode running the length of the glass structure to fabricate a fluorescent lamp. At least one of the linear glass structures has a cross-section that forms a channel which supports a plasma gas. The array of glass structures can be composed flat to form a fluorescent lamp or in a cylindrical or conical shaped fluorescent lamp.

### BRIEF DESCRIPTION OF THE DRAWING

FIG. 1 schematically illustrates a linear glass structure containing wire electrodes and a plasma channel to be used as part of a fluorescent lamp.

FIG. 2 schematically illustrates a structure similar to that shown in FIG. 1 with glass frit on the side of the glass structures.

FIG. 3 schematically shows an array of linear structures similar to that shown in FIG. 2 composed on a glass substrate.

FIG. 4 schematically shows the same array of linear structures as FIG. 3 with phosphor deposited on the glass substrate.

FIG. 5 is a top-view schematic of linear glass structures containing wire electrodes wired-up in parallel.

FIG. 6 is a top-view schematic of linear glass structures containing wire electrodes wired-up in series.

FIG. 7 schematically shows an array of linear glass structures composed on a glass substrate sealed with glass frit and a glass tab on one end of the fluorescent lamp.

FIG. 8 schematically shows a side view of FIG. 7 during the frit sealing process step.

FIG. 9 schematically shows a side view of a flat linear glass structure array fluorescent lamp with structure in the glass sealing tabs at the end to allow gas to flow from one glass structure to the next.

FIG. 10 schematically shows a linear glass structure cut at the end of the structure such that gas can flow from one structure to the next.

FIG. 11 schematically illustrates a fluorescent lamp composed of two orthogonal linear glass structure arrays with the electrodes contained in one set of glass structures.

FIG. 12 schematically illustrates a fluorescent lamp composed of two orthogonal linear glass structure arrays with the electrodes contained in both sets of glass structures.

FIG. 13 schematically illustrates a fluorescent lamp composed of two orthogonal linear glass structure arrays with the electrodes contained in one set of glass structures and the plasma channel formed by the other set of glass structures.

FIG. 14 schematically illustrates a fluorescent lamp composed of two orthogonal linear glass structure arrays with the electrodes contained in both sets of glass structures and the plasma channel formed by only one set of the glass structures.

FIG. 15 schematically illustrates a fluorescent lamp composed of linear glass structures that form the plasma channels that are coated with red, green and blue phosphors.

FIG. 16 schematically illustrates a rectangular fluorescent lamp shade constructed using linear glass structures with wire electrode.

FIG. 17 schematically illustrates a cylindrical tube fluorescent lamp constructed using linear glass structures with wire electrodes.

FIG. 18 schematically shows a fluorescent lamp with a plug on one end and a receptacle on the other end.

### DETAILED DESCRIPTION OF THE INVENTION

In its basic form, the lamp of the present invention uses at least one array of linear glass structures that contain at least one wire electrode running the length of the glass structure to fabricate a fluorescent lamp. At least one of the linear glass structures has a cross-section that forms a channel 25 which supports a plasma gas. The array of glass structures can be composed flat to form a fluorescent lamp or in a cylindrical or conical shaped fluorescent lamp.

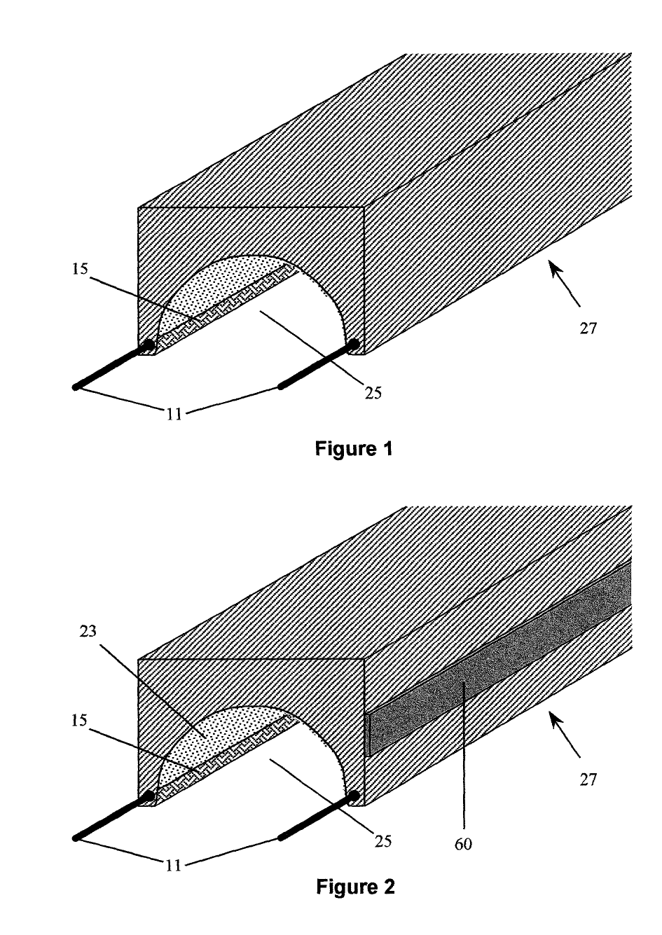

FIG. 1 schematically shows a single linear glass structure 27 containing wire electrodes 11. The linear glass structure 27 contains an arch/channel 25 on one of its surfaces, which is coated with a phosphor layer 23. The arch/channel 25 in the glass structure is the part of the structure that supports the pressure from the low-pressure plasma gas. A hard emissive coating 15, such as magnesium oxide, is place on the surface of the structure around the wire electrodes 11 in order to increase the secondary electron emission, store charge, and lower the sustaining voltage of the fluorescent lamp.

The wire electrodes 11 contained in the glass structure can be fabricated by drawing wires into holes placed through an initial glass preform during a draw fabrication process. The initial glass preforms, which have a similar cross-sectional shape to the final linear glass structures 27, can be fabricated using a hot glass extrusion process. The linear glass structures 27 could also be formed directly using hot glass extrusion or the shape can be drawn through a die directly from the glass melt. The wire electrodes could be feed through the die during direct extrusion or drawing from a glass melt.

The wire electrodes 11 could be totally contained within the glass structure 27 and the plasma inside the lamp would be capacitively coupled to. On the other hand, the wire electrodes 11 could be designed such that they are exposed to the plasma and the plasma inside the lamp could be inductively coupled to. One method of exposing the wire electrodes 11 to the plasma gas would be to use a lost glass process where a sacrificial or dissolvable glass is added to the glass structure 27 during its initial formation to contain the wire electrodes 11 then subsequently removed. A dissolvable glass can be co-extruded with the base glass to directly form the glass structures 27 or form a preform for the draw process. The wire electrodes 11 can be drawn into the glass structures 27 and the dissolvable glass can be subsequently removed with a liquid solution. Typical liquid solutions to dissolve the glass include vinegar and lemon juice. A dissolvable glass may be used to hold the wire electrode(s) 11 in a particular location during the draw process. When the dissolvable glass is removed the electrode(s) 11 becomes exposed to the environment outside the glass structure 27. A dissolvable glass may also be used to hold a tight tolerance in shape of the glass structure 27 during the draw process. The dissolvable glass can be removed during the draw process before the glass structures are wound onto the drum, or the glass can be removed while the glass structures are wrapped on the drum, or the glass can be removed after the glass structures have been removed from the drum as a sheet.

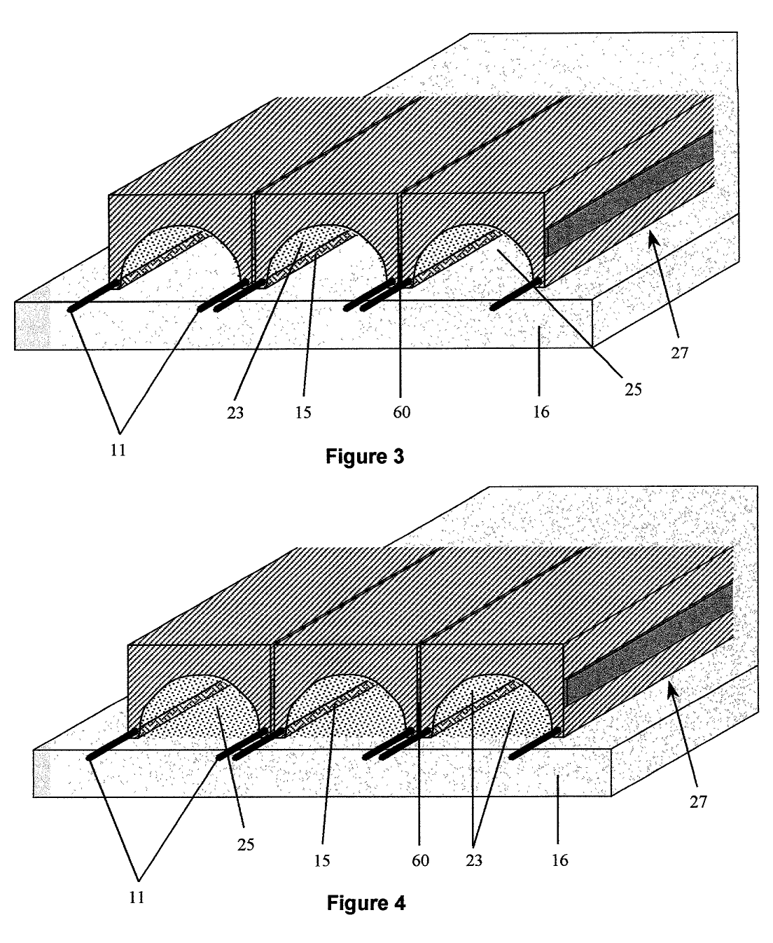

FIG. 2 shows that a thin glass frit layer 60 can be included on at least one side of the linear glass structure 27 such that when the structures 27 are arrayed on a glass substrate 16, as shown in FIG. 3, they form a vacuum tight seal. The glass frit 60 on the side of the glass structures creating a vacuum tight seal will eliminate the need for a top glass cover sheet, hence reducing the weight and lowering the cost of the lamp. The glass substrate 16 can also be coated with a phosphor layer 23 similar to the phosphor layer 23 coated in the arch/channel 25 of the linear glass structures 27, as shown in FIG. 4. Coating the glass substrate 16 with phosphor 23 will increase the usage of generated ultraviolet, UV, light by converting the UV striking the glass substrate 16 to visible light, hence increasing the efficiency and light output of the fluorescent lamp. The phosphor 23 layers can be applied to the arch/channel 25 in the linear glass structure 27 and/or the glass substrate 16 using a spray process, which will uniformly and controllably coat the surfaces.

The linear glass structures 27 could also be composed of a reflective glass, such as an opal glass, to reflect some of the light generated by the phosphors that would typically escape out of the back of the lamp.

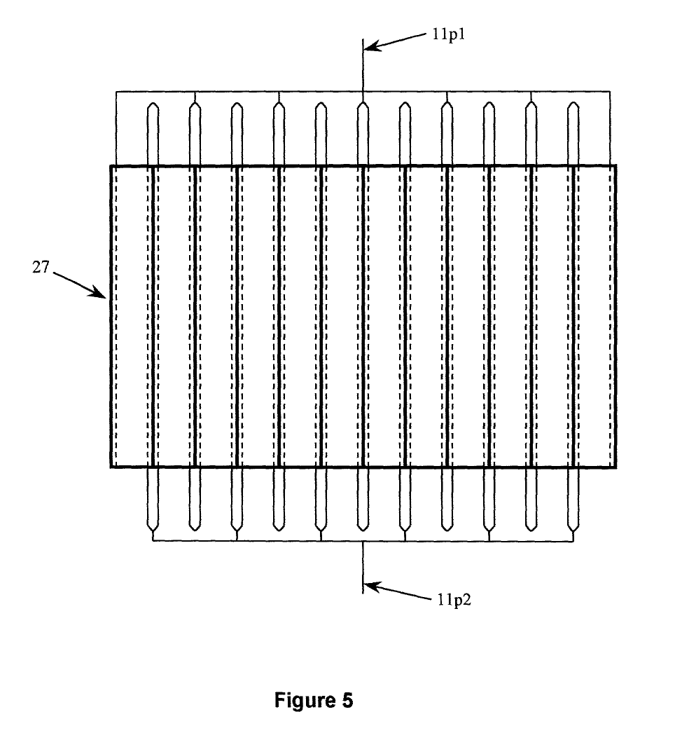

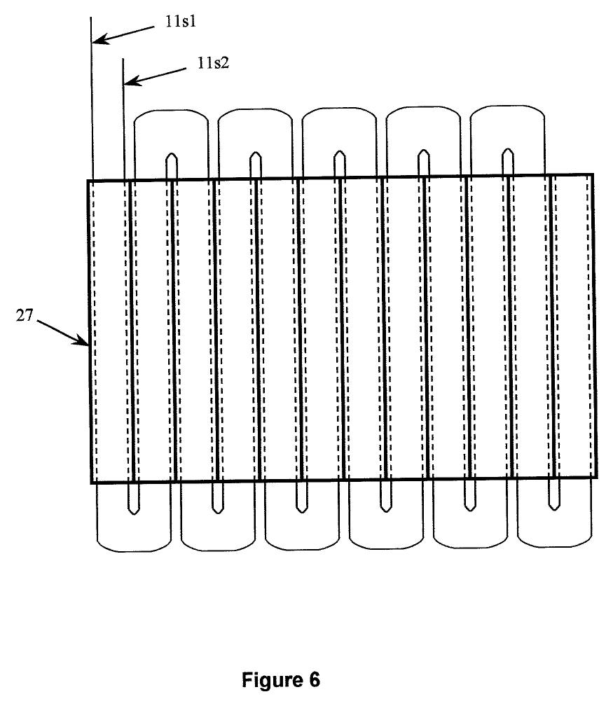

FIGS. 5 and 6 show two methods of connecting the wire electrodes 11 in the linear glass structures 27 to form two leads to power the lamp. FIG. 5 shows a method of connecting the wire electrodes in parallel with leads 11p1 and 11p2. FIG. 6 shows a method of connecting the wire electrodes in series with leads 11s1 and 11s2. FIGS. 5 and 6 depict a wiring diagram for linear glass structures 27 with two wire electrodes in a single glass structure and the plasma is ignited in the plane of the glass substrate 16. FIGS. 12 and 14 schematically show two orthogonal arrays of linear glass structures with wire electrodes in both glass structures. In this case, the electrodes in the lamp could also be wired together in either a parallel or series connection, however, the plasma would be ignited perpendicular to the plane of the glass structure arrays.

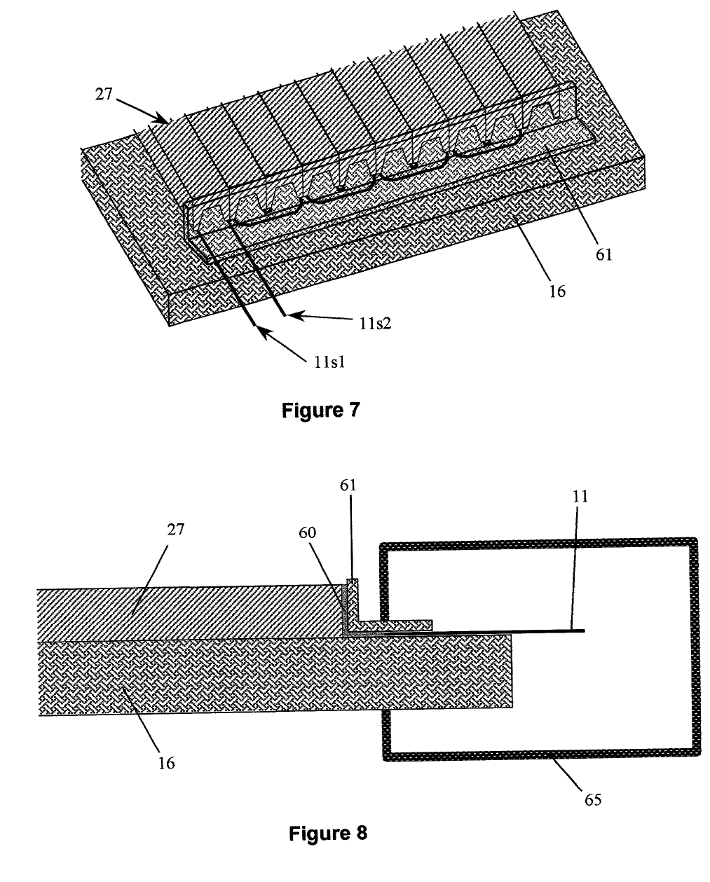

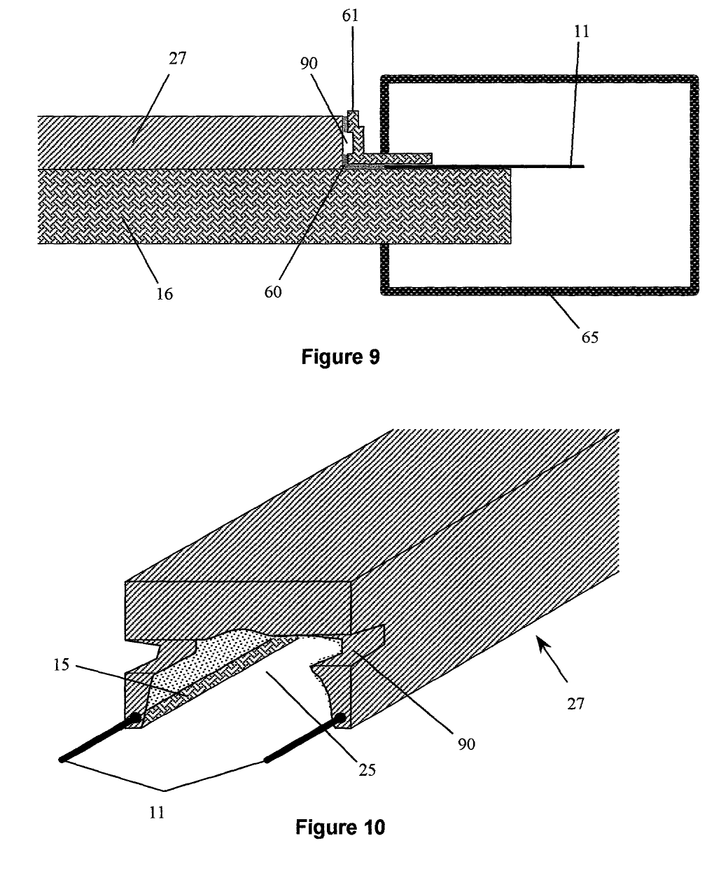

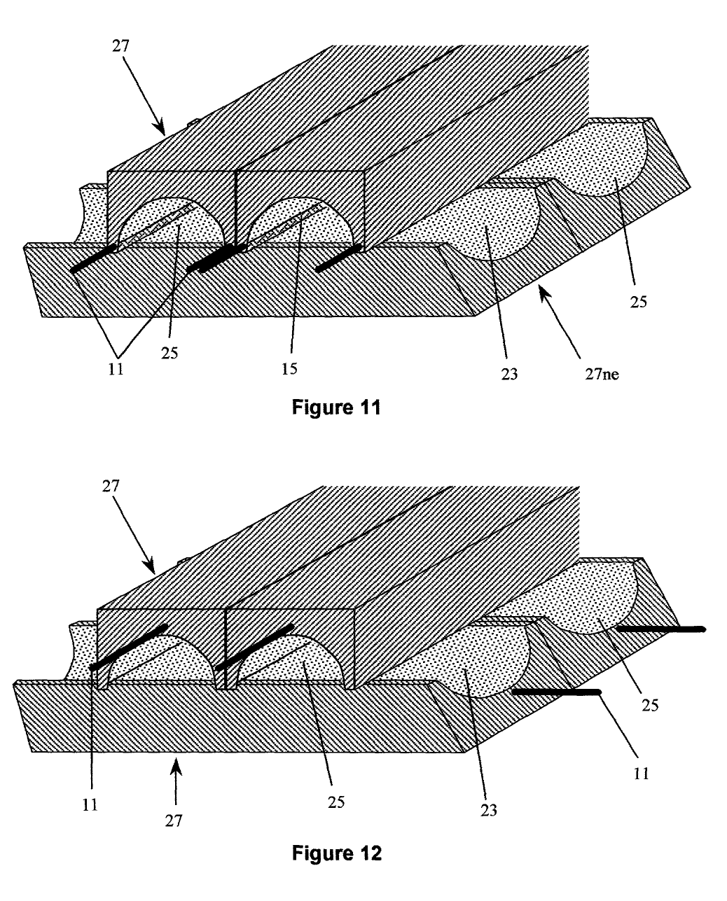

FIGS. 7 and 8 show a method of hermetically sealing the ends of the linear glass structure arrays 27 using glass tabs 61 and glass frit 60. In the frit sealing process, an L-shaped glass tab 61 containing glass frit 60 is clamped to the glass substrate 16 over the wire electrodes 11 at the end of the linear glass structure array 27 using a high temperature spring clamp 65. During the high temperature process step, the glass frit flows and produces a hermetic seal between the linear glass structures 27, glass tab 61, and glass substrate 16. The glass frit 60 also flows over the wire electrode 11 electrically isolating them from each other. The glass tabs 61 with glass frit 60 can be clamped around the entire lamp to create a hermetic seal between the linear glass structures 27 and the glass substrate 16. In addition another glass substrate can be added to the top of the linear glass structure array 27 and this glass substrate can be hermetically sealed to the bottom glass substrate using the glass tabs 61 and sealing frit 60. The glass tabs 61 to seal the lamp can take on any shape in order to force the frit 60 to flow and hermetically seal the lamp.

One potential problem in producing a fluorescent lamp with a linear glass structure array 27 shown in FIG. 7 is the ability of the plasma gas to flow from one linear glass structure 27 to the next. One method to solve this gas flow problem is to add a recess 90 to the glass tab 61 at the end of the linear glass structure 27. This recess 90 will allow the gas to flow from one glass structure 27 to the next. Another method is to cut a groove 90 in the end of the linear glass structure 27 so the gas can flow from one linear structure to the next. Another method would be to add spacers between the linear glass structures 27 and the glass substrate 16. The spacers would raise the linear glass structures 27 up form the glass substrate 16 allowing for a path for the gas to flow.

FIG. 11 shows the structure of a fluorescent lamp composed of two orthogonal arrays of linear glass structures. In this example not only can the gas flow from one linear glass structure to the next, but the plasma can easily spread from one plasma cell region to the next. This easy spreading of the plasma will create a much more uniform fluorescent lamp. FIG. 11 shows a top linear glass structure array 27 containing a plasma cell region and paired wire electrodes 11 placed over top of and orthogonal to a second linear glass structure 27ne without electrodes, but containing a plasma cell region. FIG. 12 also shows the structure of a fluorescent lamp composed of two orthogonal arrays of linear glass structures. Both glass structures 27 making up the arrays are identical and contain a plasma cell region 25 as well as wire electrodes 11. One major difference in the two lamps in FIGS. 11 and 12 is the lack of an emissive layer 15 in the lamp shown in FIG. 12. Firing onto a phosphor-coated region, as would be the case in the lamp shown in FIG. 12, usually increases the operating voltage of the lamp. However, if the lamp were operated at a high enough frequency, such that there are always electrons and/or ionized species present to support the plasma, a low firing voltage would be obtained.

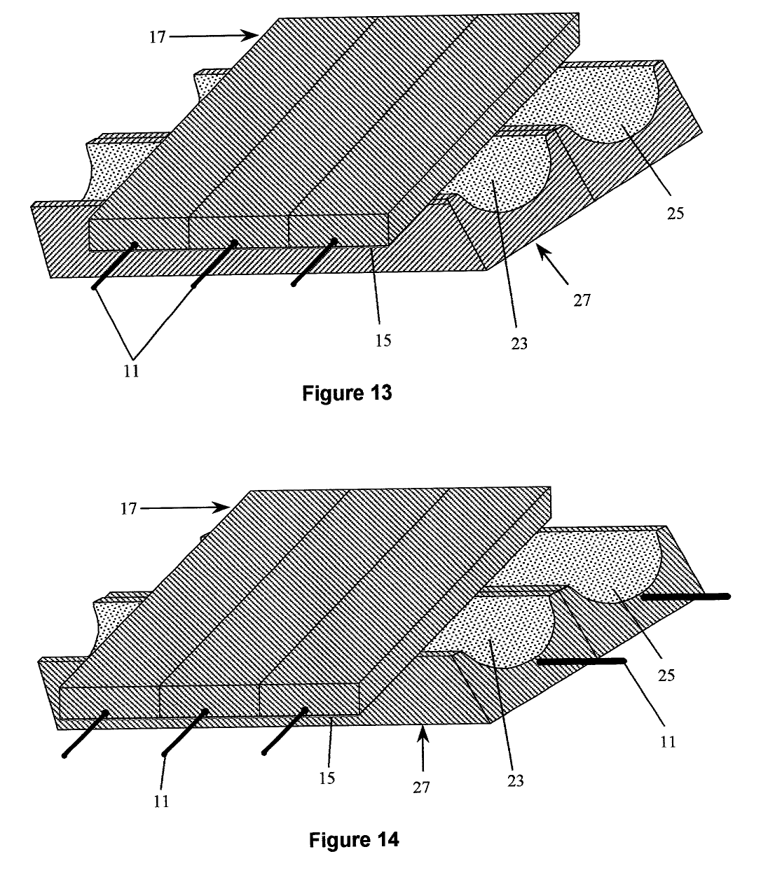

FIGS. 13 and 14 show a fluorescent lamp composed of two arrays of linear glass structures with one array of glass structures forming the plasma cell regions in the lamp. FIG. 13 shows a lamp configuration where the top linear glass structure array 17 contains both sets of wire electrodes 11 and the bottom linear glass structure array 27 forms the plasma cell regions 25. FIG. 14 shows a lamp configuration where the top linear glass structure array 17 contains one set of wire electrodes 11 and the bottom linear glass structure array 27 contains the other set of wire electrodes 11 and the plasma cell regions 25. A thin hard emissive film 15, such as magnesium oxide, is deposited on the surface of the top linear glass structures 17 to enhance the secondary electron emission and reduce sputtering from ion bombardment over the electrode region.

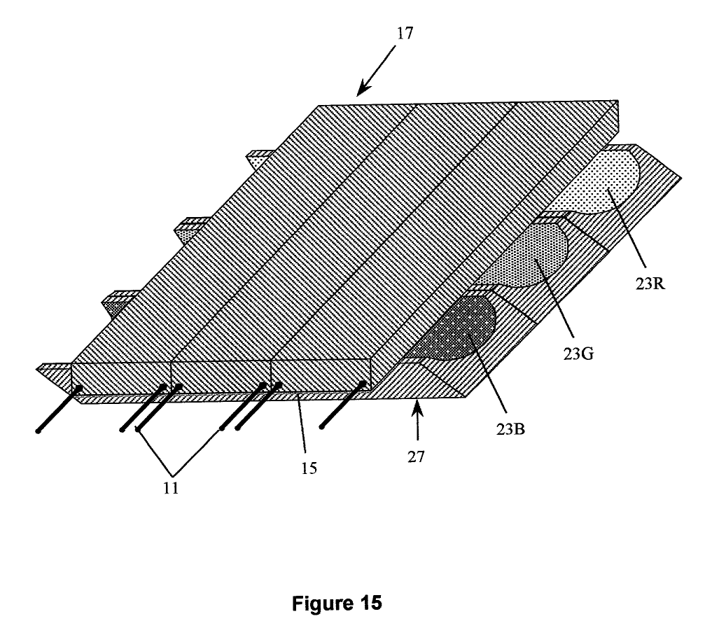

In order to produce a decorative fluorescent lamp, such as a lampshade, alternating phosphor 23 colors can be deposited in the plasma channels 25. FIG. 15 shows a lamp constructed of two orthogonal linear glass structure arrays with red 23R, green 23B, and blue 23B phosphor layers coated in the channel 25 of the bottom glass structures. These phosphor 23 coated channels 25 can be spray coated then arranged in a sequencing RGB order.

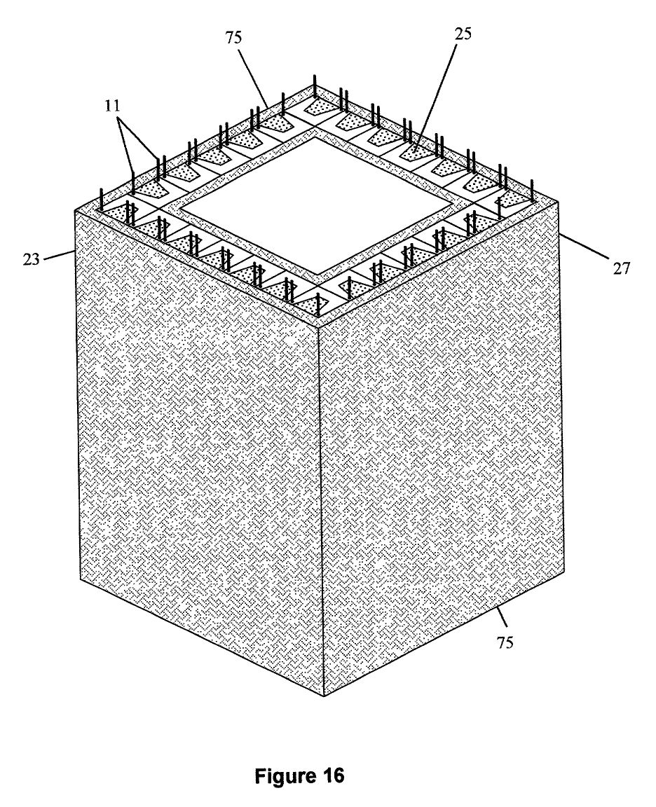

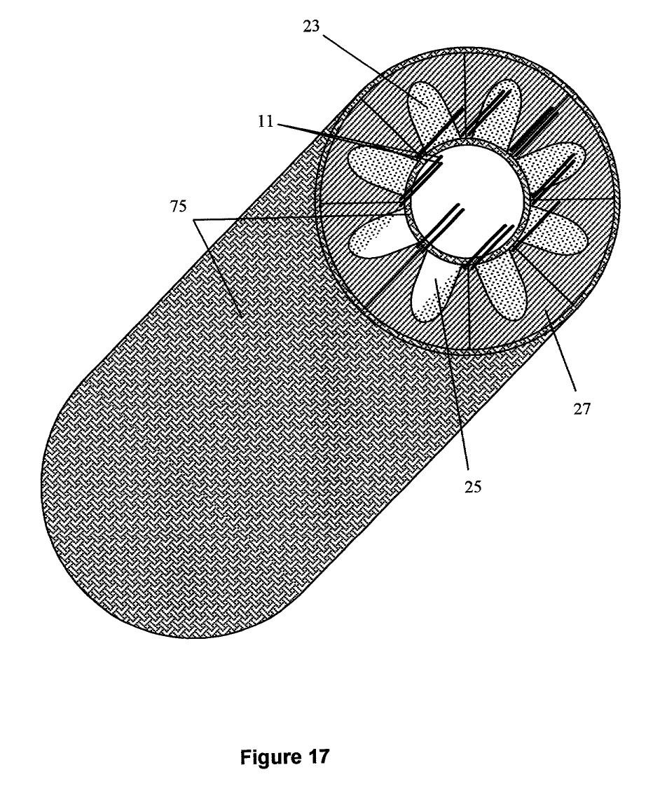

FIG. 16 shows a rectangular fluorescent lamp composed of two rectangular glass sleeve 75 with linear glass structures 27 arrayed between the glass sleeves 75 to form a lamp. Choosing small or few linear glass structures 27 will produce compact fluorescent, whereas many and/or large glass structures 27 will produce a large fluorescent lamp that could serve as an illuminated lampshade. Changing the shape of the linear glass structures 27 will allow for the fabrication of a cylindrical fluorescent lamp, as shown in FIG. 17. This cylindrical lamp could also be designed as a compact fluorescent or an illuminated lampshade. A glass coated metal wire or a thin small glass structure containing a wire electrode could be wrapped around a curved surface to create a curved fluorescent lamp.

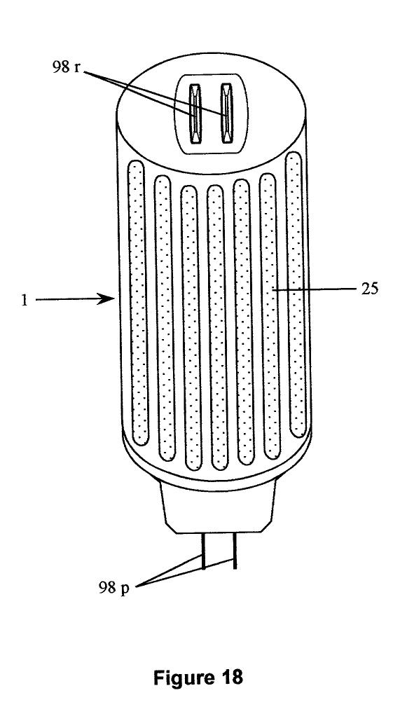

FIG. 18 shows a compact fluorescent 1 with an electrical plug 98p on one end and an electrical receptacle 98r on the other end. Using a solid structured member, such as could be formed with glass cylinders 75 and linear glass structures 27, to form the compact fluorescent would give the structure enough strength for an electrical receptacle on one end of the lamp.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A fluorescent lamp composing at least one glass structure containing at least one wire electrode extending over 50% of the length of said glass structure.

2. A lamp in claim 1, wherein said glass structure contains a channel which forms a plasma channel in said lamp.

3. A lamp in claim 2, wherein said channel is coated with a phosphor layer to create white light.

4. A lamp in claim 2, wherein said channel is coated with a phosphor layer to impart color in said lamp.

5. A lamp in claim 2, wherein said channel is spray coated with a phosphor layer.

6. A lamp in claim 1, wherein part of said structure is coated with an emissive film.

7. A lamp in claim 1, wherein said wire electrodes are wired in parallel.

8. A lamp in claim 1, wherein said wire electrodes are wired in series.

9. A lamp in claim 1, wherein the electricity is capacitively coupled to the plasma through a portion of said glass structure from said wire electrode.

10. A lamp in claim 1, wherein at least a portion of at least one glass structure contains an opal glass to reflect at least 5% of any light generated entering said opal region.

11. A lamp in claim 1, wherein the ends of said at least one glass structure is covered with a glass frit to hermetically seal said lamp.

12. A lamp in claim 11, wherein said frit is forced to flow using glass tabs.

13. A lamp in claim 11, wherein said frit covers said wire electrodes to electrically isolate said wires form each other.

14. A fluorescent lamp comprising at least one array of glass structures containing wire electrodes sandwiched between two glass plates.

15. A fluorescent lamp comprising at least one array of glass structures wherein said glass structures are hermetically sealed together using a glass frit to form a surface of said lamp.

16. A fluorescent lamp comprising at least one glass structure containing at least one wire electrode which has been exposed to the outside environment using a lost glass process.

17. A fluorescent lamp comprising at least one glass structure where the shape of the glass structure is altered using a lost glass process.

18. A fluorescent lamp comprising at least one glass structure containing at least one wire electrode bent onto a curved surface.

19. A lamp in claim 1, wherein said lamp serves as a compact fluorescent.

20. A lamp in claim 1, wherein said lamp serves as an illuminated surface.

21. A lamp in claim 1, wherein said lamp serves as a lampshade.

22. A fluorescent lamp comprising a plug on one end of the lamp and a receptacle on the other end of the lamp.
